(19) United States
(12) Patent Application Publication
(10) Pub. No.: US 2012/0119055 A1
(43) Pub. Date: May 17, 2012

(54) Clip

(75) Inventor: Kohei Mimura, Osaka (JP)

(73) Assignee: NIFCO INC., Yokohama-shi (JP)

(21) Appl. No.: 13/373,393

(22) Filed: Nov. 14, 2011

(30) Foreign Application Priority Data
Nov. 15, 2010 (JP) 2010-255141

(51) Int. Cl. H01Q 1/12

(52) U.S. Cl. 248/540

(57) ABSTRACT

A clip includes a first member and a second member, forming a cylindrical body by mutually engaging together. Each of the first member and the second member includes a printed-substrate holding portion for holding a plate-like printed substrate, an antenna-element holding portion for holding a cylinder-like antenna element attached to the printed substrate, and an engaging portion for mutually engaging the first and second members.

### BACKGROUND OF THE INVENTION AND RELATED ART STATEMENT

The present invention relates to a clip for attaching an antenna element to a printed substrate.

Conventionally, as a structure attaching the antenna element to the printed substrate, for example, there is Japanese Patent No. 391007 (Patent Document 1). In the conventional technology, in a nondirectional antenna of a PHS and the like, for example, a conductor of copper, brass, or the like is used, and a plurality of antenna elements structured in a semicircular shape is attached to a sheet of the printed substrate.

However, in the Patent Document 1, it is required to fix the antenna elements to the printed substrate by soldering and the like. Consequently, assembly-hours of the antenna elements to the printed substrate increase, so that assembly workability is not excellent.

The present invention is made in view of the aforementioned fact and has an object to obtain a clip capable of improving the assembly workability of the antenna elements to the printed substrate.

Further objects and advantages of the invention will be apparent from the following description of the invention.

### SUMMARY OF THE INVENTION

A clip of the present invention according to the first aspect comprises a first member and a second member forming a cylindrical body by mutually engaging. The first member and the second member include a printed-substrate holding portion holding a plate-like printed substrate; an antenna-element holding portion holding a cylinder-like antenna element attached to the printed substrate; and an engaging portion for mutually engaging.

In the clip of the present invention according to the first aspect, due to each printed-substrate holding portion in the first member and the second member forming the cylindrical body by mutually engaging the engaging portions, the plate-like printed substrate can be held. Also, due to each antenna-element holding portion in the first member and the second member, the cylinder-like antenna element attached to the printed substrate can be held. Consequently, through the clip, the antenna element can be easily attached to the printed substrate.

As for the present invention according to the second aspect, in the clip according to the first aspect, the printed-substrate holding portion is a groove portion formed in an inner circumferential portion of the cylindrical body and clamping an edge portion of the printed substrate.

In the clip of the present invention according to the second aspect, the groove portion, formed in the inner circumferential portion of the cylindrical body formed by the first member and the second member, clamps the edge portion of the printed substrate so as to prevent a rotation of the printed substrate in a circumferential direction (a direction around a shaft center) of the clip which is the cylindrical body.

As for the present invention according to the third aspect, in the clip according to the first or second aspect, the printed- substrate holding portion is a shaft portion formed in the inner circumferential portion of the cylindrical body, and inserted to pass through a through-hole of the printed substrate.

In the clip of the present invention according to the third aspect, the shaft portion, formed in the inner circumferential portion of the cylindrical body formed by the first member and the second member, is inserted and passes through the through-hole of the printed substrate so as to prevent a movement of the printed substrate in a shaft center direction of the clip which is the cylindrical body.

As for the present invention according to the fourth aspect, in the clip according to any one of the first to third aspects, the antenna-element holding portion is a convex portion formed in an outer circumferential portion of the cylindrical body and engaging a concave portion of the antenna element.

In the clip of the present invention according to the fourth aspect, the convex portion formed in the outer circumferential portion of the cylindrical body engages the concave portion of the antenna element so as to prevent a rotation of the antenna element in the circumferential direction of the clip which is the cylindrical body.

As for the invention according to the fifth aspect, in the clip according to any one of the first to fourth aspects, the antenna-element holding portion is a claw portion formed in the outer circumferential portion of the cylindrical body, locked in a locking portion of the antenna element, and capable of elastically deforming.

In the clip of the present invention according to the fifth aspect, the claw portion, formed in the outer circumferential portion of the cylindrical body and capable of elastically deforming, is locked in the locking portion of the antenna element so as to prevent a movement of the antenna element in the shaft center direction of the clip which is the cylindrical body.

As for the invention according to the sixth aspect, in the clip according to any one of the first to fifth aspects, the engaging portion engaging the first member and the second member is the claw portion capable of elastically deforming and the convex portion engaging the claw portion.

In the clip of the present invention according to the sixth aspect, the claw portion formed in one of either the first member or the second member and capable of elastically deforming, and the convex portion formed in the other of either the first member or the second member are engaged, so that the first member and the second member are easily connected.

As for the invention according to the seventh aspect, in the clip according to any one of the first to fifth aspects, the engaging portion engaging the first member and the second member is the claw portion capable of elastically deforming, and an engaging hole engaging the claw portion.

In the clip of the present invention according to the seventh aspect, the claw portion formed in one of either the first member or the second member and capable of elastically deforming, and the engaging hole formed in the other of either the first member or the second member are engaged, so that the first member and the second member are easily connected.

As for the invention according to the eighth aspect, in the clip according to the seventh aspect, the first member and the second member have the same shape.

In the clip of the present invention according to the eighth aspect, the first member and the second member have the same shape so as to reduce a forming die.

As for the invention according to the ninth aspect, in the clip according to the eighth aspect, the first member and the second member are connected by a hinge portion.

In the clip of the present invention according to the ninth aspect, since the first member and the second member are connected by the hinge portion, the first member and the second member become one member so as to reduce the number of components.

In the clip of the present invention according to the first aspect, due to the aforementioned structure, assembly workability of the antenna element to the printed substrate can be improved.

In the clip of the present invention according to the second aspect, due to the aforementioned structure, the rotation of the printed substrate in the circumferential direction of the clip which is the cylindrical body can be prevented.

In the clip of the present invention according to the third aspect, due to the aforementioned structure, the movement of the printed substrate in the shaft center direction of the clip which is the cylindrical body can be prevented.

In the clip of the present invention according to the fourth aspect, due to the aforementioned structure, the rotation of the antenna element in the circumferential direction of the clip which is the cylindrical body can be prevented.

In the clip of the present invention according to the fifth aspect, due to the aforementioned structure, the movement of the antenna element in the shaft center direction of the clip which is the cylindrical body can be prevented.

In the clip of the present invention according to the sixth aspect, due to the aforementioned structure, the first member and the second member can be easily connected.

In the clip of the present invention according to the seventh aspect, due to the aforementioned structure, the first member and the second member can be easily connected.

In the clip of the present invention according to the eighth aspect, due to the aforementioned structure, the forming die can be reduced.

In the clip of the present invention according to the ninth aspect, due to the aforementioned structure, the number of the components can be reduced.

### BRIEF DESCRIPTION OF THE DRAWINGS

FIG. 1 is an exploded perspective view showing a printed substrate, antenna elements, and a clip according to a first embodiment of the present invention;

FIG. 2 is a perspective view showing the printed substrate and the antenna elements according to the first embodiment of the present invention;

FIG. 3 is a perspective view showing the printed substrate, the antenna elements, the clip, and a radome according to the first embodiment of the present invention;

FIG. 4 is an exploded perspective view showing a first clip according to the first embodiment of the present invention;

FIG. 5 is a perspective view showing the first clip according to the first embodiment of the present invention;

FIG. 6 is an exploded perspective view showing a second clip according to the first embodiment of the present invention;

FIG. 7 is a perspective view showing the second clip according to the first embodiment of the present invention;

FIG. 8 is a perspective view showing a condition before an engagement of the first clip according to a second embodiment of the present invention;

FIG. 9 is a perspective view showing the first clip according to the second embodiment of the present invention;

FIG. 10 is an exploded perspective view showing the second clip according to the second embodiment of the present invention; and

FIG. 11 is a perspective view showing the second clip according to the second embodiment of the present invention.

### DETAILED DESCRIPTION OF PREFERRED EMBODIMENTS

### First Embodiment

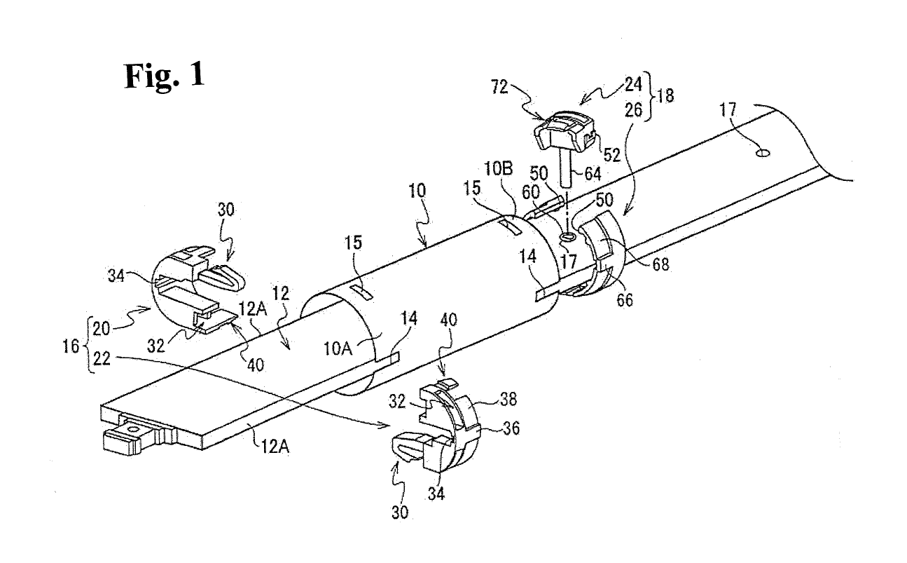

Next, a first embodiment of a clip of the present invention will be explained in accordance with FIGS. 1 to 7.

Incidentally, an arrow X in the drawings shows a shaft center direction of the clip which is a cylindrical body, an arrow Y in the drawings shows a radial direction of the clip, and an arrow Z in the drawings shows a circumferential direction of the clip.

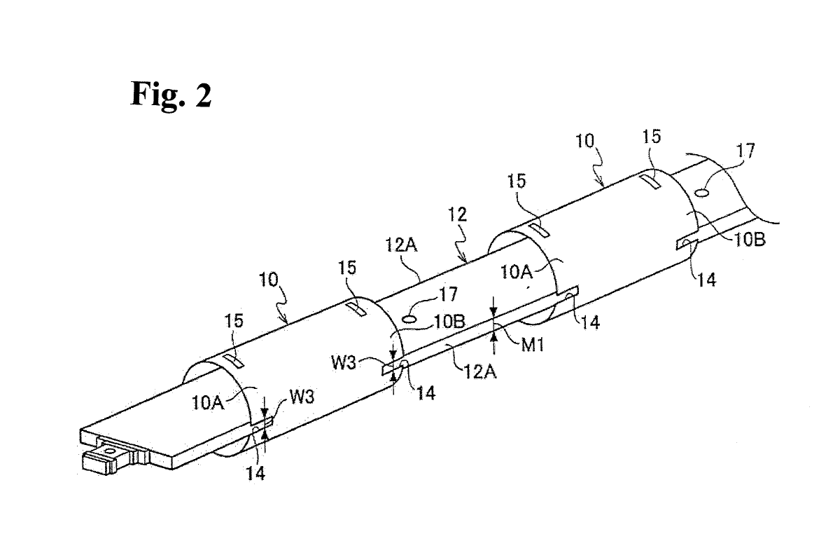

As shown in FIG. 2, in the present embodiment, antenna elements 10 are structured by a conductor of copper, brass, or the like so as to be in a cylindrical shape. On both end portions 10A and 10B in a longitudinal direction (the shaft center direction) of the antenna elements 10, a pair of notches 14 as a concave portion is formed in a linear fashion along the longitudinal direction of the antenna elements 10, and a pair of the notches 14 is formed in a position, for example, 180 degrees away in the circumferential direction. Also, on both end portions 10A and 10B of the antenna elements 10, a pair of through-holes 15 as a locking portion is formed in the linear fashion along the circumferential direction, and a pair of the through-holes 15 is formed in a position, for example, 90 degrees away from each notch 14 in the circumferential direction.

On the other hand, a printed substrate 12 has a rectangular plate shape whose thickness is M1, and circular through-holes 17 are formed at a predetermined interval along the longitudinal direction. Incidentally, in the printed substrate 12, an electric circuit which is not shown in the drawings is formed. Also, a plurality of the antenna elements 10 is attached to the printed substrate 12 so as to have a structure in which the printed substrate 12 is inserted and passes through an inner circumference of the cylinder-shaped antenna elements 10.

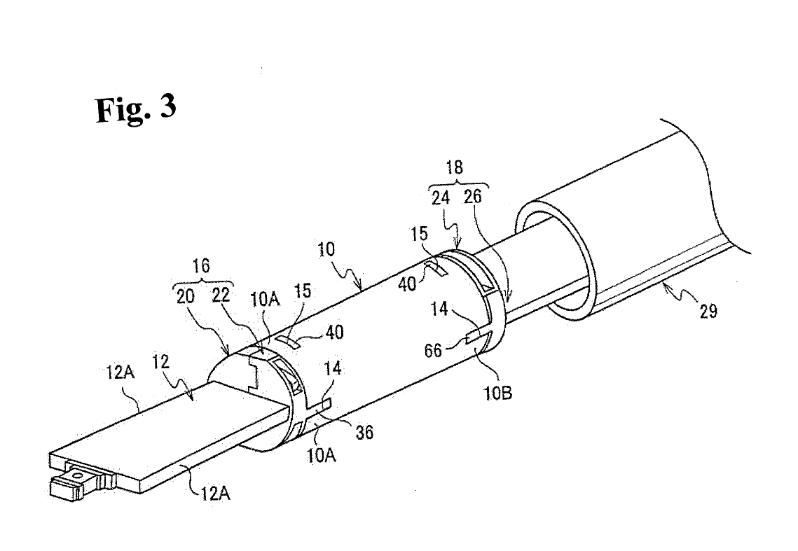

As shown in FIG. 3, one end portion 10A of the antenna element 10 is fixed to the printed substrate 12 by a first clip (a support clip) 16 as the clip. Also, the other end portion 10B of the antenna element 10 is fixed to the printed substrate 12 by a second clip 18 (a main clip) as the clip.

Incidentally, a plurality of the antenna elements 10, fixed to the printed substrate 12 by the first clip 16 and the second clip 18, is covered by a cylindrical radome 29, and the radome 29 is constituted by, for example, FRP.

As shown in FIG. 1, the first clip 16 is constituted by a first member 20 and a second member 22, and the second clip 18 is constituted by a first member 24 and a second member 26.

(First Clip)

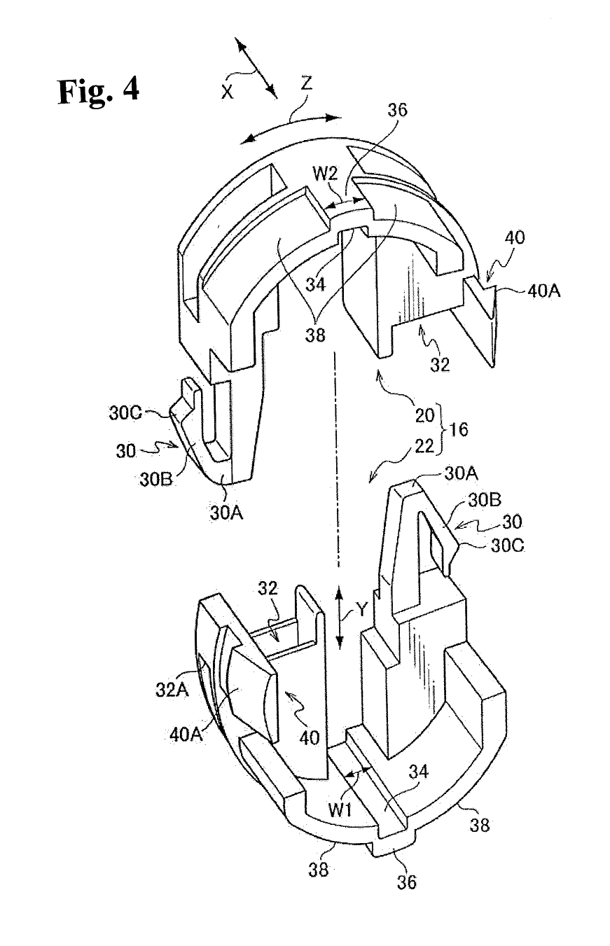

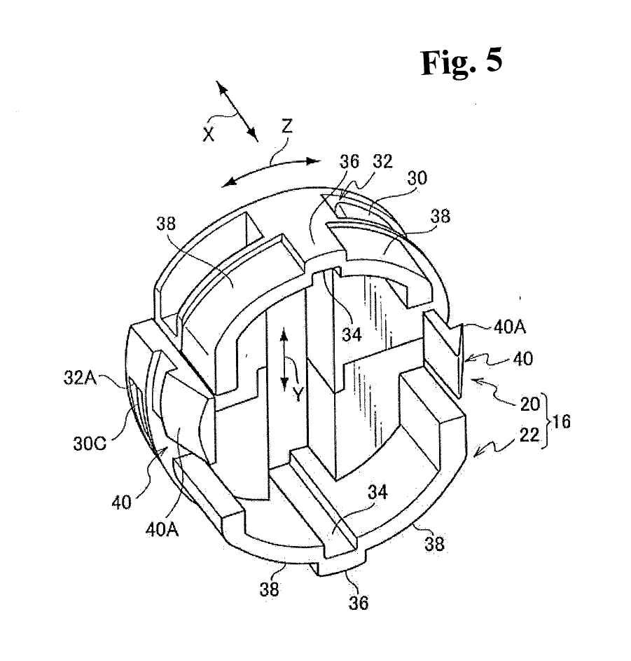

Next, the first clip will be explained in accordance with FIGS. 4 and 5.

As shown in FIG. 4, the first clip 16 comprises claw portions 30 capable of elastically deforming as engaging portions mutually engaging the first member 20 and the second member 22, and engaging holes 32 as the engaging portions engaging the claw portions 30.

As shown in FIG. 5, the first member 20 and the second member 22 are mutually engaged by the claw portions 30 and the engaging holes 32 so as to form the first clip 16 as the cylindrical body.

As shown in FIG. 4, the first member 20 and the second member 22 are the same shape with a semicircular shape, and from one end portion in the circumferential direction, the claw portions 30 are formed by protruding along the radial direction (the arrow Y direction) of the first clip 16. The claw portions are turned back to an outer circumferential side from end portions 30A, and near the end portions of turned-back portions 30B, convex portions 30C are formed by protruding toward the outer circumferential side. On the other hand, on the other end portions in the circumferential direction in the first member 20 and the second member 22, the engaging holes 32 are formed along the radial direction.

As shown in. FIG. 5, the claw portions 30 can be inserted into the engaging holes 32, and the turned-back portions 30B elastically deform, so that the convex portions 30C of the claw portions 30 inserted into the engaging holes 32 pass through the engaging holes 32 so as to engage outer-circumferential-side edge portions 32A of the engaging holes 32.

As shown in FIG. 4, in center portions in the circumferential direction in inner circumferential portions of the first member 20 and the second member 22, groove portions 34 as printed-substrate holding portions are formed along the shaft center direction (the arrow X direction) of the first clip 16. A width W1 of the groove portion 34 is approximately equal to a thickness of both-side edge portions 12A of the printed substrate 12, and the both-side edge portions 12A of the printed substrate 12 are clamped by the groove portions 34 so as to be capable of preventing the first clip 16 and the printed substrate 12 from relatively rotating in the circumferential direction (the arrow Z direction) of the first clip 16.

In the center portions (the outer circumferential sides of the groove portions 34) in the circumferential direction in the outer circumferential portions of the first member 20 and the second member 22, convex portions 36 as antenna-element holding portions are formed along the shaft center direction of the first clip 16. A width W2 of the convex portion 36 is approximately equal to a width W3 (see FIG. 2) of the notches 14 of the antenna elements 10, and as shown in FIG. 3, the convex portions 36 are inserted into the notches 14 of the antenna elements 10 so as to be capable of preventing the first clip 16 and a plurality of the antenna elements 10 from relatively rotating in the circumferential direction of the first clip 16.

Incidentally, both side portions of the convex portion 36 in the outer circumferential portions of the first member 20 and the second member 22 are antenna-element supporting portions 38 supporting the end portions 10A and 10B in the longitudinal direction of the antenna element 10 from an inner circumferential side.

As shown in FIG. 4, in the end portions in the circumferential direction on an engaging hole 32 side in the outer circumferential portions of the first member 20 and the second member 22, claw portions 40 as the antenna-element holding portions are formed by protruding along the shaft center direction of the first clip 16. Near the end portions of the claw portions 40, convex portions 40A are formed by facing an outside. The claw portions 40 elastically deform, so that the convex portions 40A engage the through-holes 15 of the antenna elements 10. Thereby, the first clip 16 and the antenna elements 10 can be prevented from relatively moving in the shaft center direction of the first clip 16.

(Second Clip)

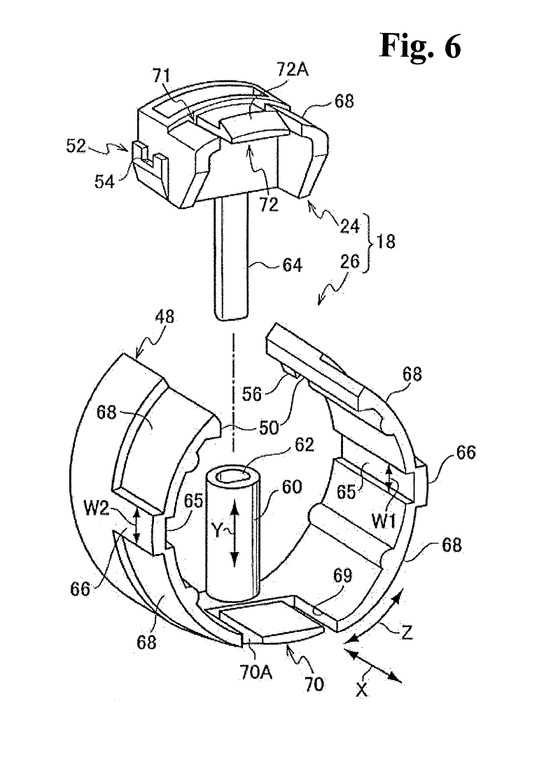

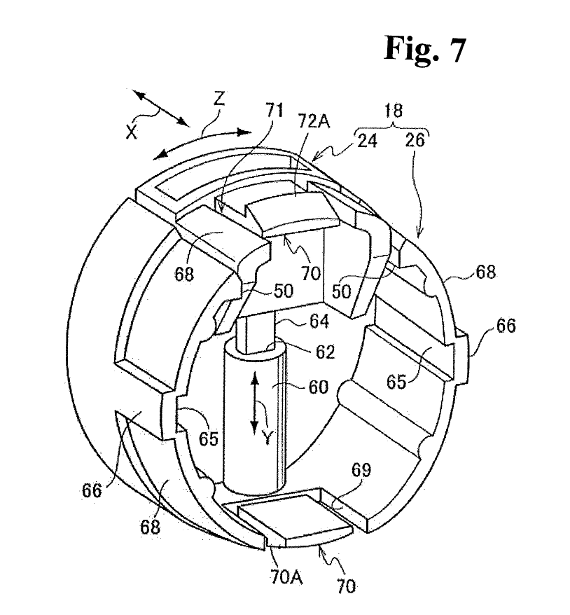

Next, the second clip will be explained in accordance with FIGS. 6 and 7.

As shown in FIG. 6, in the second member 26 of the second clip 18, a notch 48 is formed in one portion of the outer circumferential portion, and both end portions along the circumferential direction (the arrow Z direction) of the second clip 18 in the second member 26 have a pair of claw portions 50 capable of elastically deforming as the engaging portion. On the other hand, the first member 24 of the second clip 18 has a circular shape forming the second clip 18 as the cylindrical body by being inserted into the notch 48 of the second member 26.

On both end portions along the circumferential direction of the first member 24, convex portions 52 as the engaging portions are formed, and a pair of the claw portions 50 of the second member 26 engages the convex portions 52. Incidentally, in an intermediate portion in the shaft center direction of the convex portions 52, concave portions 54 are formed, and convex portions 56 formed in an intermediate portion in the shaft center direction in the claw portions 50 of the second member 26 engage the concave portions 54, so that the claw portions 50 and the convex portions 52 are allowed not to relatively move in the shaft center direction of the second clip 18.

In a center portion in the circumferential direction of the second member 26, a female shaft portion 60 as the printed-substrate holding portion is provided by standing toward a center of the second clip 18, and the female shaft portion 60 is inserted into the through-hole 17 of the printed substrate 12 shown in FIG. 1 so as to be capable of preventing the second clip 18 and the printed substrate 12 from relatively moving in the shaft center direction of the second clip 18, and also capable of preventing the second clip 18 and the printed substrate 12 from relatively rotating in the circumferential direction. Incidentally, the female shaft portion 60 has a cylindrical shape, and an inner circumferential hole 62 has a cross-sectional shape of, for example, a D-shape.

On the other hand, in a center portion in the circumferential direction of the first member 24, a male shaft portion 64 as the printed-substrate holding portion is provided by standing toward the center of the second clip 18. The male shaft portion 64 has a cross-sectional shape of the D-shape, and by inserting the male shaft portion 64 into the inner circumferential hole 62 of the female shaft portion 60 of the second member 26, an engaging direction between the first member 24 and the second member 26 is determined.

In a position 90 degrees away in both directions along the circumferential direction of the second clip 18 from the female shaft portion 60 in an inner circumferential portion of the second member 26, groove portions 65 as the printed-substrate holding portions are formed along the shaft center direction (the arrow X direction) of the second clip 18. A width W1 of the groove portions 65 is approximately equal to the thickness M1 of the both-side edge portions 12A of the printed substrate 12, and the both-side edge portions 12A of the printed substrate 12 are clamped by the groove portions 65 so as to be capable of preventing the second clip 18 and the printed substrate 12 from relatively rotating in the circumferential direction of the second clip 18.

In a position (an outer circumferential side of the groove portions 65) 90 degrees away from the female shaft portion 60 along the circumferential direction (the arrow Z direction) of the second clip 18 in the outer circumferential portion of the second member 26, a pair of convex portions 66 as the antenna-element holding portion is formed along the shaft center direction of the second clip 18. A width W2 of the convex portions 66 is approximately equal to the width W3 (see FIG. 2) of the notches of the antenna elements 10, and as shown in FIG. 3, the convex portions 66 are inserted into the notches 14 of the antenna elements 10 so as to be capable of preventing the second clip 18 and the antenna elements 10 from relatively rotating in the circumferential direction of the second clip 18.

Incidentally, both side portions of the convex portions 66 in the outer circumferential portions of the first member 24 and the second member 26 are antenna-element supporting portions 68 supporting the end portion 10B in the longitudinal direction of the antenna element 10 from the inner circumferential side.

In a center portion in the circumferential direction of the antenna-element supporting portions 68 in the second member 26, notches 69 are formed, and inside the notches 69, a claw portion 70 as the antenna-element holding portion is formed by protruding in the shaft center direction of the second clip 18. Near an end portion of the claw portion 70, a convex portion 70A is formed toward an outer circumferential side. The claw portion -70 elastically deforms, so that the convex portion 70A engages the through-holes 15 of the antenna elements 10.

On the other hand, in a portion of the antenna-element supporting portions 68 of the first member 24 facing the notches 69 of the second member 26, notches 71 are formed, and inside the notches 71, a claw portion 72 as the antenna-element holding portion is formed by protruding in the shaft center direction of the second clip 18. Near an end portion of the claw portion 72, a convex portion 72A is formed toward the outer circumferential side. The claw portion 72 elastically deforms, so that the convex portion 72A engages the through-holes 15 of the antenna elements 10.

Thereby, the second clip 18 and the antenna elements 10 can be prevented from relatively moving in the shaft center direction of the second clip 18.

(Operation and Effect)

In the present embodiment, in a case wherein the antenna elements 10 are assembled in the printed substrate 12 by the first clip 16 and the second clip 18, at first, as shown in FIG. 2, a plurality of the antenna elements 10 and the printed substrate 12 are assembled in such a way that the rectangular plate-like printed substrate 12 passes through an inside of the cylinder- shaped antenna elements 10.

Next, as shown in FIG. 1, the second clip 18 is assembled in the end portion 10B of the antenna element 10.

More specifically, the female shaft portion 60 of the second member 26 of the second clip 18 is inserted into the through-hole of the printed substrate 12. After that, the male shaft portion 64 of the first member 24 is inserted into the female shaft portion 60 of the second member 26, and also a pair of the claw portions 50 of the second member 26 is engaged with a pair of the convex portions 52 of the first member 24 so as to engage the first member 24 and the second member 26. Thereby, the first member 24 and the second member 26 are connected so as to form the cylindrical body.

At this time, the both-side edge portions 12A of the printed substrate 12 are clamped by a pair of the groove portions 65 of the second member 26 so as to be capable of preventing the second clip 18 and the printed substrate 12 from relatively rotating in the circumferential direction of the second clip 18.

Also, the antenna element 10 is slid in a direction approaching the second clip 18, and the antenna-element supporting portions 68 of the second clip 18 are inserted into the inner circumferential side of the end portion 10B of the antenna element 10. Thereby, a pair of the convex portions 66 of the second member 26 is inserted into the notches 14 of the antenna element 10. As a result, the second clip 18 and the antenna element 10 can be prevented from relatively rotating in the circumferential direction of the second clip 18.

Moreover, when the antenna element 10 is slid in the direction approaching the second clip 18, the convex portion 70A of the claw portion 70 of the first member 24 and the convex portion 72A of the claw portion 72 of the second member 22 engage the through-holes 15 of the antenna element 10. As a result, the second clip 18 and the antenna element 10 can be prevented from relatively moving in the shaft center direction of the second clip 18.

Also, the female shaft portion 60 of the second member 26 is inserted into the through-hole 17 of the printed substrate 12 so as to be capable of preventing the antenna element 10 assembled with the second clip 18 from moving in the longitudinal direction (the shaft center direction of the second clip 18) of the printed substrate 12, and also preventing the antenna element 10 assembled with the second clip 18 from rotating in the direction around the shaft center (the circumferential direction of the second clip 18) of the printed substrate 12.

Next, the first clip 16 is assembled in the end portion 10A of the antenna element 10. At this time, the first clip 16 is assembled in such a way as to sandwich the printed substrate 12 by the first member 20 and the second member 22 which are the same shape.

More specifically, the claw portion 30 of the first member 20 is inserted into the engaging hole 32 of the second member 22, and the claw portion 30 of the second member 22 is inserted into the engaging hole 32 of the first member 20. Thereby, the convex portion 30C of the claw portion 30 inserted into the engaging hole 32 engages the outer-circumferential-side edge portion 32A of the engaging hole 32, so that the first member 20 and the second member 22 are connected so as to form the cylindrical body.

At this time, the both-side edge portions 12A of the printed substrate 12 are clamped by each groove portion 34 of the first member 20 and the second member 22 so as to be capable of preventing the first clip 16 and the printed substrate 12 from relatively rotating in the circumferential direction of the first clip 16.

Next, the first clip 16 is slid in a direction approaching the antenna element 10, and the antenna-element supporting portions 38 are inserted into the inner circumferential side of the end-portion 10A of the antenna element 10. Thereby, each convex portion 36 of the first member 20 and the second member 22 is inserted into the notches 14 of the antenna element 10. As a result, the first clip 16 and the antenna element 10 can be prevented from relatively rotating in the circumferential direction of the first clip 16.

Moreover, the first clip 16 is slid in the direction approaching the antenna element 10, and the convex portion 40A of the claw portion 40 of the first member 20 and the second member 22 is engaged with the through-hole 15 of the antenna element 10. As a result, the first clip 16 and the antenna element 10 can be prevented from relatively moving in the shaft center direction of the first clip 16.

As a result, due to the second clip 18 and the first clip 16, the antenna element 10 can be positioned in the printed substrate 12.

At last, as shown in FIG. 3, a plurality of the antenna elements 10 assembled in the printed substrate 12 by the second clip 18 and the first clip 16 is covered by the radome 29.

Consequently, in the present embodiment, through the second clip 18 and the first clip 16, the antenna element 10 can be easily assembled in the printed substrate 12 so as to be capable of improving assembly workability of the antenna element 10 to the printed substrate 12.

Also, in the first clip 16 of the present embodiment, the claw portions 30, formed in the first member 20 and the second member 22 and capable of elastically deforming, and the engaging holes 32 are engaged so as to be capable of easily connecting the first member 20 and the second member 22. Moreover, since the first clip 16 is not constituted as an annular shape, the printed substrate 12 is not required to pass through the first clip 16, and the first clip 16 can be assembled in such a way as to sandwich the printed substrate 12. Consequently, the assembly workability of a plurality of the antenna elements 10 to the printed substrate 12 can be improved further.

Also, in the second clip 18 of the present embodiment, the claw portions 50, formed in the second member 26 and capable of elastically deforming, and the convex portions 52 formed in the first member 24 are engaged so as to be capable of easily connecting the first member 24 and the second member 26. Consequently, the assembling workability of the antenna elements 10 to the printed substrate 12 can be improved further.

Moreover, in the first clip 16 of the present embodiment, the first member 20 and the second member 22 are the same shape so as to be capable of reducing a forming die.

### Second Embodiment

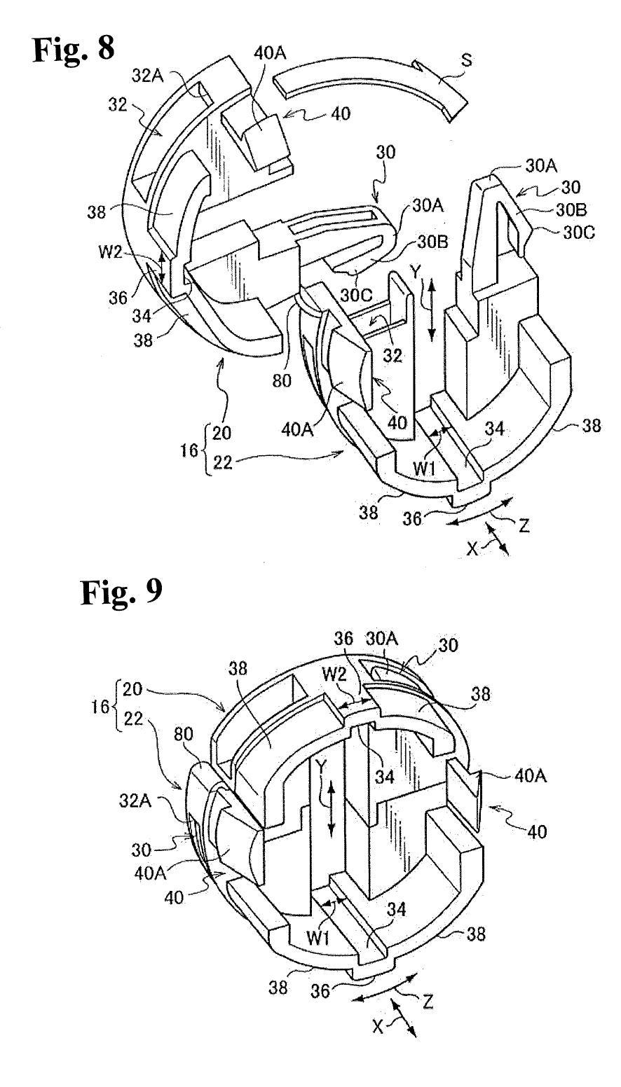

Next, a second embodiment of the clip of the present invention will be explained in accordance with FIGS. 8 to 11.

Incidentally, the same symbols are assigned to the same members as the first embodiment, and their explanations are omitted.

(First Clip)

Next, the first clip (the support clip) will be explained in accordance with FIGS. 8 and 9.

As shown in FIGS. 8 and 9, in the present embodiment, the end portion on a claw portion 30 side along the circumferential direction of the first clip 16 in the first member 20 in the first clip 16, and the end portion on the engaging hole 32 side along the circumferential direction of the first clip 16 in the second member 22 are connected by a hinge portion 80. Therefore, as a starting point of the hinge portion 80, for example, the first member 20 is rotated in a direction of the second member 22 (an arrow S direction in FIG. 8) so as to be capable of connecting the first member 20 and the second member 22.

(Second Clip)

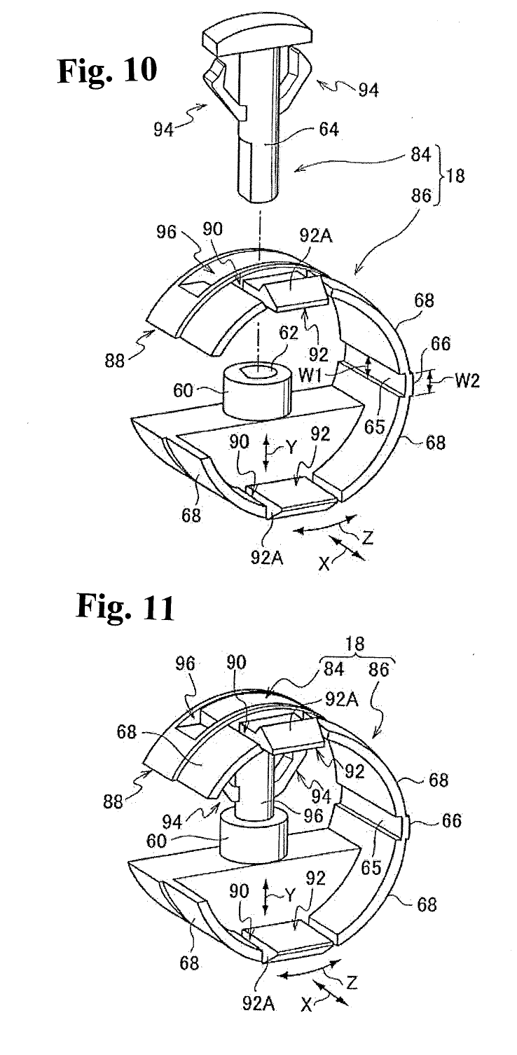

Next, the second clip (the main clip) will be explained in accordance with FIGS. 10 and 11.

As shown in FIGS. 10 and 11, in a second member 86 of the second clip 18 of the present embodiment, a notch 88 is formed in one portion of the outer circumferential portion, and in a portion of the inner circumferential portion facing the notch 88, the groove portion 65 as the printed-substrate holding portion is formed along the shaft center direction (the arrow X direction) of the second clip. Also, the width W1 of the groove portion 65 is approximately equal to the thickness M1 of the both-side edge portions 12A of the printed substrate 12.

Therefore, the printed substrate 12 shown in FIGS. 1 to 3 is inserted into an inside of the second member 86 through the notch 88, and one of the side edge portions 12A of the printed substrate 12 is clamped by the groove portion 65 so as to be capable of preventing the second clip 18 and the printed substrate 12 from relatively rotating in the circumferential direction (the arrow Z direction) of the second clip 18.

Also, on the outer circumferential side of the groove portion 65, the convex portion 66 as the antenna-element holding portion is formed along the shaft center direction (the arrow X direction) of the second clip 18. The width W2 of the convex portion 66 is approximately equal to the width W3 of the notches 14 of the antenna elements 10 shown in FIG. 2, and the convex portion 66 is inserted into the notch 14 of the antenna element 10 so as to be capable of preventing the second clip 18 and the antenna element 10 from relatively rotating in the circumferential direction of the second clip 18.

Incidentally, both the side portions of the convex portion 66 in the outer circumferential portion of the second member 86 are the antenna-element supporting portions 68 supporting the end portion 10B in the longitudinal direction of the antenna element 10 from the inner circumferential side.

In a position 90 degrees away in both directions along the circumferential direction of the second clip 18 from the convex portion 66 in the antenna-element supporting portions 68 of the second member 26, notches 90 are respectively formed. Inside the notches 90, claw portions 92 as the antenna-element holding portions are formed by protruding in the shaft center direction of the second clip 18. Near the end portions of the claw portions 92, convex portions 92A are formed toward the outer circumferential side, and the claw portions 92 elastically deform, so that the convex portions 92A engage the through-holes 15 of the antenna element 10.

Thereby, the second clip 18 and the antenna element 10 can be prevented from relatively moving in the shaft center direction of the second clip 18.

Near a base portion of one of the claw portions 92 in the second member 86, an engaging hole 96 as the engaging portion is formed, and in a portion of the inner circumferential portion of the second member 86 facing the engaging hole 96, the female shaft portion 60 as the printed-substrate holding portion is provided by standing toward the center of the second clip 18. As a result, the printed substrate 12 is inserted into the inside of the second member 86 through the notch 88, and the female shaft portion 60 is inserted into the through-hole 17 of the printed substrate 12 so as to be capable of preventing the second clip and the printed substrate 12 from moving in the shaft center direction of the second clip 18, and also preventing the second clip and the printed substrate 12 from relatively rotating in the circumferential direction.

Specifically, the antenna element 10 assembled with the second clip 18 can be prevented from moving in the longitudinal direction (the shaft center direction of the second clip 18) of the printed substrate 12, and also prevented from rotating in the direction around the shaft center (the circumferential direction of the second clip 18) of the printed substrate 12. Also, the female shaft portion 60 has the cylindrical shape, and the inner circumferential hole 62 has the cross-sectional shape of the D-shape.

On the other hand, in a center portion in the circumferential direction of a first member 84, the male shaft portion 64 as the printed-substrate holding portion is provided by standing toward the center of the second clip 18. A lower portion of the male shaft portion 64 has the cross-sectional shape of the D-shape, and can be inserted into the hole 62 of the female shaft portion 60 of the first member 24.

On an outer circumference of an upper portion of the male shaft portion 64 in the first member 84, a pair of claw portions capable of elastically deforming as the engaging portion is formed in the position 180 degrees away in the circumferential direction.

As shown in FIG. 11, when the first member 84 is inserted into the engaging hole 96 of the second member 86, the lower portion of the male shaft portion 64 enters into the female shaft portion 60 of the first member 24, and also a pair of the claw portions 94 engages a circumferential edge portion on the inner circumferential side of the engaging hole 96 so as to form the second clip 18 as the cylindrical body.

(Operation and Effect)

In the present embodiment, the same operational effect as the first embodiment can be obtained, and also in the first clip 16 of the present embodiment, the first member 20 and the second member 22 are mutually connected by the hinge portion 80. Consequently, the first clip 16 is constituted as one component so as to be capable of reducing the number of components.

### Other Embodiments

Hereinbefore, although the specific embodiments of the present invention have been explained in detail, the present invention is not limited to the aforementioned respective embodiments, and it is obvious to those skilled in the art that other various embodiments can be made within a range of the present invention. For example, in the respective embodiments, although the first clip 16 and the second clip 18 are the circular cylindrical body conformed to the cylinder-shaped antenna elements 10, in a case wherein the antenna elements 10 have other shapes such as a short-form cylinder shape and the like, the first clip 16 and the second clip 18 may be other cylindrical bodies such as a short form and the like conformed to the shape of the antenna elements 10.

The disclosure of Japanese. Patent Application No. 2010-255141, filed on Nov. 15, 2010, is incorporated in the application.

What is claimed is:

1. A clip, comprising:
a first member and a second member, forming a cylindrical body by mutually engaging together;
wherein each of the first member and the second member comprises a printed-substrate holding portion for holding a plate-like printed substrate; an antenna-element holding portion for holding a cylindrical antenna element attached to the printed substrate; and an engaging portion for mutually engaging the first and second members.

2. A clip according to claim 1, wherein the printed-substrate holding portion is a groove portion formed in an inner circumferential portion of the cylindrical body for clamping an edge portion of the printed substrate.

3. A clip according to claim 1, wherein the printed-substrate holding portion is a shaft portion formed in the inner circumferential portion of the cylindrical body and inserted to pass through a through-hole of the printed substrate.

4. A clip according to claim 1, wherein the antenna-element holding portion is a convex portion formed in an outer circumferential portion of the cylindrical body and engaging a concave portion of the antenna element.

5. A clip according to claim 1, wherein the antenna-element holding portion is a claw portion formed in the outer circumferential portion of the cylindrical body, to be locked in a locking portion of the antenna element, and capable of elastically deforming.

6. A clip according to claim 1, wherein the engaging portions engaging the first member and the second member are a claw portion capable of elastically deforming, and a convex portion engaging the claw portion:

7. A clip according to claim 1, wherein the engaging portions engaging the first member and the second member are a claw portion capable of elastically deforming, and an engaging hole engaging the claw portion.

8. A clip according to claim 7, wherein the first member and the second member have a same shape.

9. A clip according to claim 8, wherein the first member and the second member are connected by a hinge portion.
